(19) United States
(12) Patent Application Publication
(10) Pub. No.: US 2016/0267816 A1
(43) Pub. Date: Sep. 15, 2016

(54) TWO SIDED PRINTED LABEL WITH ADHESIVE

(71) Applicants: Austin Daniel Anderson, Dacula, GA (US); Jean Michelle Lane, Naperville, IL (US); Robert Shinkle, II, Peachtree Corners, GA (US)

(72) Inventors: Austin Daniel Anderson, Dacula, GA (US); Jean Michelle Lane, Naperville, IL (US); Robert Shinkle, II, Peachtree Corners, GA (US)

(21) Appl. No.: 14/644,922

(22) Filed: Mar. 11, 2015

(51) Int. Cl. G09F 3/02; G06Q 20/20; G09F 3/10; B41J 2/32; B41J 3/407

(52) U.S. Cl. CPC G09F 3/02; B41J 2/32; B41J 3/4075; G09F 3/10; G06Q 20/209; G09F 2003/0202; G09F 2003/0283

(57) ABSTRACT

Embodiments of a printer, label, and methods for printing the label are generally described herein. A printer for printing on two sides of a label may include a first print head to print on a first side of the label, and a second print head to print on a second side of the label, the second side opposite the first side and including an adhesive area and an adhesive-free area. The printer may include wherein the second print head is to print on the second side in the adhesive-free area.

### BACKGROUND

Linerless label rolls are used throughout the world to print labels, receipts, and product orders. Some solutions involving linerless label rolls include printed information on two sides of a label to save paper. One drawback to these solutions is that they could not include printed information on the same side as an adhesive.

### SUMMARY

In various embodiments, methods and systems for a printer, a label, and printing on the label are presented.

According to an embodiment, a printer for printing on two sides of a label is provided. Specifically, the printer includes a first print head to print on a first side of the label, a second print head to print on a second side of the label, the second side opposite the first side and including an adhesive area and an adhesive-free area, and wherein the second print head is to print on the second side in the adhesive-free area.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1C are diagrams of a label in different configurations, according to an example embodiment.

FIG. 2 is a diagram of a printer, according to an example embodiment.

FIG. 3 is a diagram of a top view of a printer, according to an example embodiment.

FIG. 4 is a diagram of a linerless label roll, according to an example embodiment.

FIGS. 5A-5B are diagrams of a label including preprinted areas, according to an example embodiment.

FIG. 6A-6B are diagrams of food wrapper labels, according to an example embodiment.

FIG. 7 is a flowchart showing a method for printing on two sides of a label, according to an example embodiment.

### DETAILED DESCRIPTION

Labels, printers, linerless label rolls, food wrappers, and methods for using the same are described herein. A label can include information printed on both sides of the label as well as an adhesive portion on at least one of the sides. A printer can include a plurality of print heads for printing on both sides of a label. A linerless label roll can include a label with adhesive or preprinted information and the label can be printed on both sides. A food wrapper can include printed information on both sides of the wrapper, adhesive to secure the wrapper to itself, and can be used to wrap and securely contain food prepared using the printed information. A method can include printing on both sides of a label, wherein the label includes an adhesive on at least one of the sides. A label with adhesive can include sticky media.

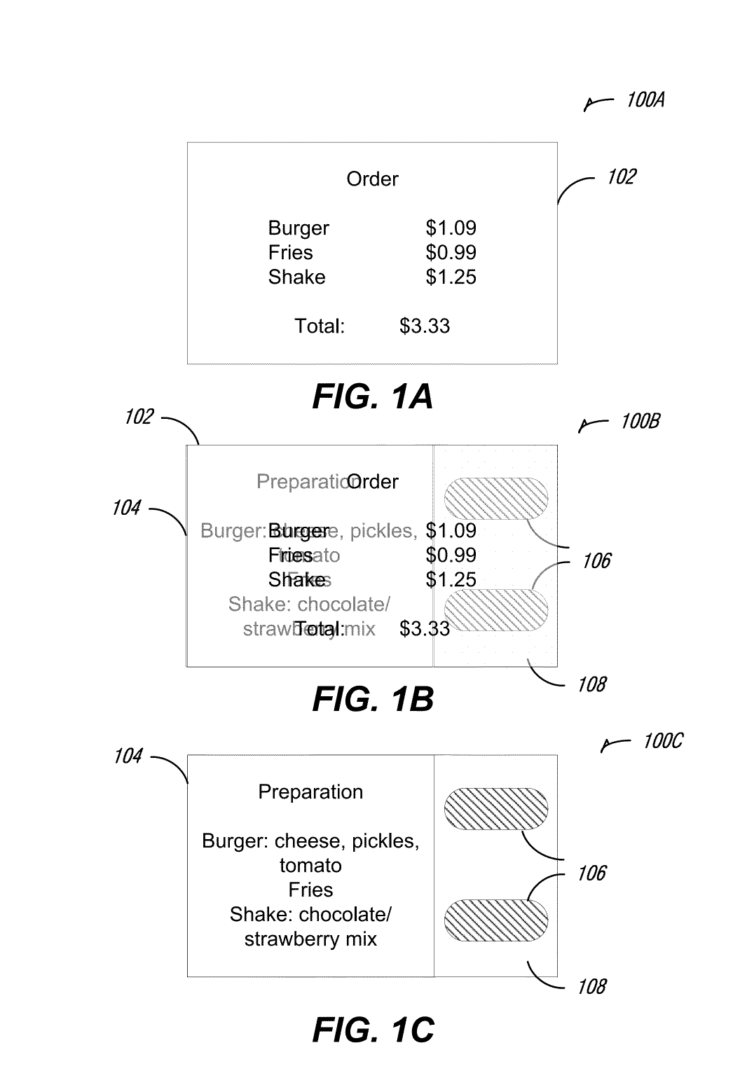

FIGS. 1A-1C are diagrams of a label in different configurations, according to an example embodiment. FIG. 1A shows the label in a first view 100A. The first view 100A can include information, such as information for a customer, transaction, end user, or the like. For example, first view 100A shows a first side 102 with order information, including various food menu items and prices, including a total amount. In another example, the first side 102 can include purchase information (e.g., a receipt, purchase order, etc.), instructions for use of a device or apparatus, such as when the label is configured to couple to the device or apparatus, or other information intended for a customer or third party (e.g., a recipe, greeting card information, a coupon, etc.). The first side 102 can include options not shown, such as an adhesive portion, preprinted information, or other options as described below.

FIG. 1B shows the label in a transparent view 100B. The transparent view 100B includes the first side 102 and a second side 104 opposite the first side. The transparent view 100B is from the perspective of a partially transparent version of the first view 100A with the second side 104 shown through the partially transparent version of the first view 100A. Transparent view 100B includes adhesive 106 on the second side 104 and an adhesive area 108 (also on the second side 104). In an example, the label can include information printed on both the first side 102 and the second side 104 as shown in transparent view 100B.

FIG. 1C shows the label in a second view 100C. The second view 100C includes the second side 104, the adhesive 106, and the adhesive area 108. In an example, the second side 104 can include printed information, including any of the information described above relating to the first side 102. In another example, the second side 104 can include printed information indicating instructions for preparation of an order, such as ingredients, preparation steps, preparation details, reminders, delivery instructions, other specified parameters (e.g., colors, sizes, order number, or the like). In another example, the second side 104 can include legal information, such as a warranty, a disclaimer, a contract, or the like.

In an example, the label can be used to prepare a product, order, device, etc., using the information on the second side 104. The label can be adhered to the product, order, device, etc. The information on the first side 102 of the label can be used by a customer, third party, user, etc., for use or information. In an example, the adhesive 106 can be used to adhere the label to a product, order, device, etc., leaving the first side 102 visible (e.g., obscuring the second side 104 partially or completely), such as to avoid confusing the customer. In another example, the first side 102 can include a removable adhesive component. The removable adhesive component can be used to preliminarily attach the label (first side 102 face down) to a product, order, device, wrapper, etc. The second side 104 (face up in this example) can include information for preparation of the product, order, device, wrapper, etc. After the product, order, device, wrapper, etc. is prepared, the label can be removed and reattached in a different position or orientation, or on a different apparatus using the adhesive 106 on the second side 104, showing the information on the first side 102 and partially or substantially completely obscuring the second side 104.

In an example, the second side 104 can include a non-adhesive area (e.g., the area of the second side 104 exclusive of the adhesive area 108, the area of the second side 104 exclusive of the adhesive 106, etc.). In an example, information printed on the second side 104 can be printed only on the non-adhesive area. The print-ready non-adhesive area of the second side 104 can be smaller than a print-ready area of the first side 102.

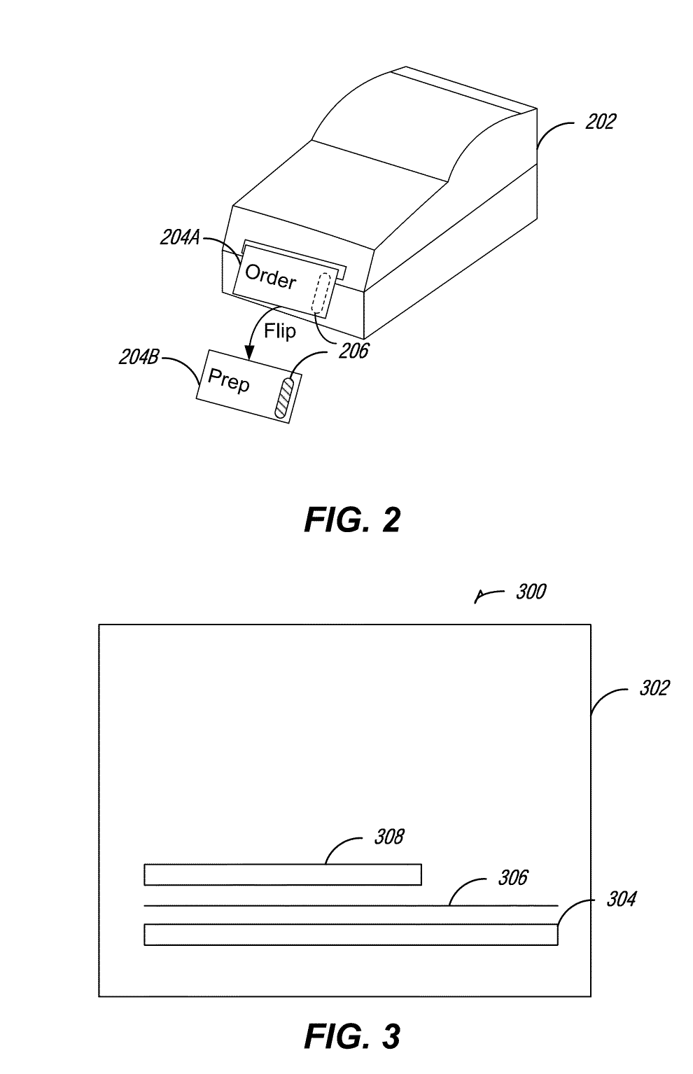

FIG. 2 is a diagram of a printer 202, according to an example embodiment. The printer 202 can print a label (e.g., 204A and 204B), such as a label from a linerless label roll. The printer 202 can include print heads configured to print on a first side 204A of the label and a second side 204B of the label. The first side 204A can include printed information (e.g., “Order” as shown in FIG. 2). The second side 204B can include printed information (e.g., “Prep” as shown in FIG. 2). The second side 204B can include an adhesive 206. In an example, the first side can include an adhesive (not shown), with or without an adhesive on the second side 204B. In an example, the first side 204A can come out of the printer 202 face up, and the second side 204B can come out face down with the adhesive 206, including printed information on both the first side 204A and the second side 204B. The adhesive 206 can be pre-applied to the linerless label roll before the roll is placed in the printer. In another example, the label can be preprinted, such as with color images, before being placed in the printer. In yet another example, the pre-applied adhesive can include preprinted information on the adhesive (e.g., “remove backing to apply adhesive”).

In an example, the printer 202 includes a thermal printer. The thermal printer can print two sided thermal labels. In another example, the printer 202 includes a laser printer. In yet another example, the thermal printer includes an inkjet printer. The printer 202 can include a plurality of print heads, as discussed below in FIG. 3. In another example, the printer 202 can use a single print head but still print on both sides of the label by having a paper roll through the print head twice. The printer 202 can include a Self-Service Terminal (SST), a point of sale (POS) device, or another device that prints a receipt, contract, confirmation, purchase order, instruction, recipe, card, direction, order, or the like.

FIG. 3 is a diagram of a side view 300 of a printer 302, according to an example embodiment. The printer 302 can be the printer 202 of FIG. 2. The side view 300 shows a cross section of the printer 302, which can be a cross section from the side, a cross section from the top, or a cross section from the front of the printer 302. The printer 302 includes a first print head 304, a paper channel 306 and a second print head 308. In an example, the first print head 304 can include a front print head, such as to print on a first side of a label (e.g., the first side 102 of the label in FIG. 1A). The second print head 308 can include, in an example, a reverse print head to print on a second side of the label (e.g., the second side 104 of the label in FIG. 1C). The paper channel 306 can include a channel to propel a label through the printer, allowing the print heads 304 and 308 to print on the label. In the example shown in FIG. 3, the second print head 308 is shorter than the first print head 304. The second print head 308 can be shorter to accommodate printing on a side of a label with an adhesive, such as the second side 204B of the label in FIG. 2 or the second side 104 of the label in FIG. 1C. The print head 308 shown in the side view 300 can print in a non-adhesive area of a label (e.g., the area of the second side 104 not in the adhesive area 108 in FIG. 1C) without printing in an adhesive area of the label (e.g., adhesive area 108 in FIG. 1C). In an example, the second print head 308 is shorter and cannot print in an adhesive area. In another example, the second print head 308 can be shorter or substantially the same length as the first print head 304, but does not print, or does not engage, in an adhesive area of a label, while printing in a non-adhesive area of the label.

In an example, the printer 302 can print on a label wherein the label is a label on a linerless label roll. The linerless label roll can feed into the paper channel 306 and the label on the linerless label roll can be printed on by the first print head 304 on a first side of the label and printed on by the second print head 308 on a second side of the label. The linerless label roll can include labels of a predetermined length, and the linerless label roll can be fed through the paper channel 306 until the length is reached. The printer 302 can include circuitry, hardware, logic controllers, mechanical devices, etc., to determine when the length is reached to stop the paper channel 306 from further progressing the linerless label roll. The printer 302 can include a mechanism to cut the linerless label roll at the predetermined length. The mechanism can include an automatic cutter or an edge that can be used to rip the linerless label roll. The mechanism can be internal or external to the printer. In another example, the linerless label roll is perforated at the predetermined length. In this example, the printer 302 may not have a mechanism to cut the linerless label roll.

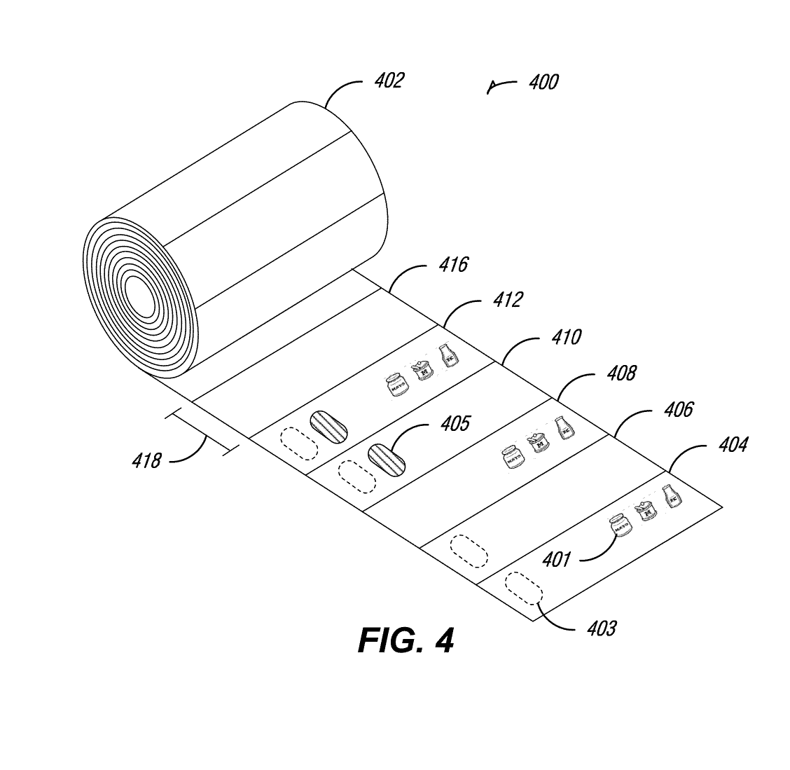

FIG. 4 is a diagram 400 of a linerless label roll 402, according to an example embodiment. The linerless label roll 402 shown in diagram 400 includes multiple example labels (e.g., 404-416). In an example, the linerless label roll 402 can include only one of these labels or a combination of any two or more labels. In another example, the linerless label roll 402 can include a combination of one or more of the labels shown in FIG. 4 with one or more other types of labels not shown. The labels (e.g., 404-416) shown in FIG. 4 are examples and can include different configurations, combinations, arrangements of features, arrangements on the linerless label roll 402, etc.

In an example, the linerless label roll 402 can include label 404. Label 404 can include a preprinted feature 401 or an adhesive 403. In the example shown in diagram 400, the adhesive 403 is on the opposite side of the preprinted feature 401 (e.g., preprinted feature 401 is on the lower right top or showing side of label 404 and the adhesive 403 is on the opposite or not showing side of label 404). In another example, the label 404 can include adhesive 403 on the same side as the preprinted feature 401. In yet another example, the label 404 can include one or more preprinted features 401 on the top side, the opposite side, or both. The preprinted feature 401 can include a color image, a black and white image, text, logos, etc.

The linerless label roll 402 includes other examples combining or omitting features or adhesives. For example, label 406 shows adhesive on the opposite side of the top/shown side. Label 408 includes a preprinted feature without adhesive. In an example, the linerless label roll 402 includes label 410. Label 410 includes adhesive 405 on the top/shown side and an adhesive on the opposite side shown with a dotted oval. In another example, the label 410 can include adhesive 405 without the opposite side adhesive. Placement of the adhesive 405 and the opposite side adhesive are representative, and other placements can be included on a label. For example, adhesive 405 and the opposite side adhesive can be opposite each other on the label 410 (e.g., they would appear partially or substantially completely overlapping on the linerless label roll 402 since it shows see-through components). In another example, linerless label roll 402 includes label 412. Label 412 shows a preprinted feature and adhesive on both sides of the label 412.

In an example, a label 416 in the linerless label roll 402 can include a predetermined length 418. As shown in FIG. 4, the predetermined length 418 can be specific to label 418, or can apply to one or more other labels (e.g., 404-412) in the linerless label roll 402. One or more of labels 404-416 can include a unique predetermined length or share a predetermined length, such as predetermined length 418. In an example, a label on the linerless label roll 402 can include any combination or arrangement of preprinted features, adhesive, a predetermined length, or printed information, including omitting one or more of those entirely (e.g., zero, one, or more than one of the label components described above, in any combination). The linerless label roll 402 can include one type of label or more than one type of label. In the example with more than one type of label, the labels can be arranged on the linerless label roll 402 in a pattern (e.g., type 1 then type 2, then repeating), arbitrarily, or sequentially (e.g., type 1 for a third of the roll then type 2 for the remaining two-thirds of the roll, half and half, etc.). The linerless label roll 402 can include a single ply, a double ply, double ply stuck together, or any combination thereof.

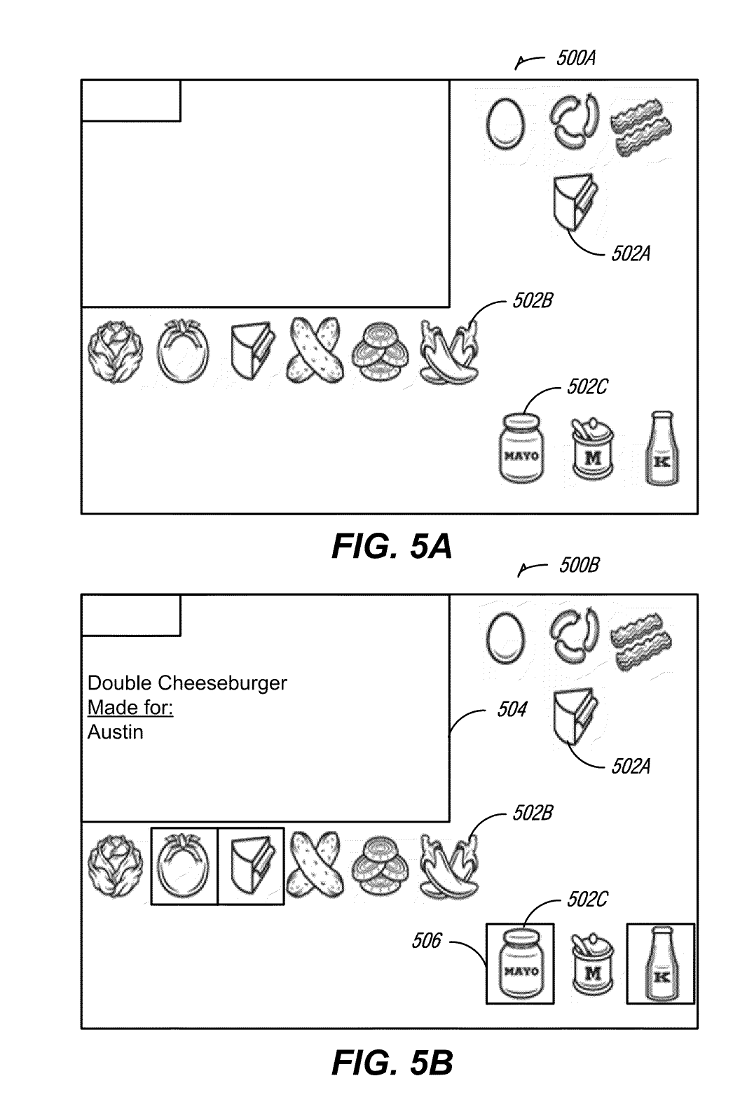

FIGS. 5A-5B are diagrams of a label (e.g., 500A and 500B) including preprinted features (e.g., 502A, 502B, or 502C), according to an example embodiment. FIG. 5A shows a first view of the label 500A before the label 500A is printed on. The label 500A includes preprinted features 502A, 502B, and 502C. The preprinted features 502A, 502B, and 502C can be in color (not shown) or black and white as shown in FIG. 5A. In the example shown in FIGS. 5A and 5B, the preprinted features 502A, 502B, and 502C include ingredients. In another example, preprinted features 502A, 502B, and 502C can include items, order information, common consumer selections, receipt information, rebate information, lottery numbers, color shapes, etc., (e.g., including information, such as pictures that would be beneficial to include in color).

FIG. 5B shows a second view of the label 500B after the label 500B is printed on. In the example shown in FIG. 5B, label 500B includes a text information printed area 504 including the text “Double Cheeseburger Made for: Austin.” The printed area 504 can include customer information, order information, nutrition information, calorie information, ingredients, handling instructions, etc. Label 500B includes a selection feature 506. The selection feature 506 can be printed by, on, around, over, near, etc., the preprinted features 502A, 502B, and 502C. In the example shown in FIG. 5B, selection feature 506 is printed around preprinted feature 502C. Preprinted feature 502C includes a picture of mayonnaise, which in an example, can be preprinted in color. Selection feature 506 can be printed in black ink around preprinted feature 502C to show that the “Double cheeseburger” printed in the printed area 504 should include mayonnaise. In the example shown in FIG. 5B, the label 500B thus includes instructions for preparation of a double cheeseburger (e.g., using selection feature 506 to show preprinted feature 502C should be added to the double cheeseburger). In an example, the label 500B can include adhesive (e.g., on the side shown, the opposite side, or both). In an example, the adhesive can be used to attach the label 500B to a food wrapper containing the double cheeseburger prepared using the instructions printed and preprinted on the label 500B. Other examples not shown can include instructions for packaging a shipment, preparing a gift basket, arranging an order, etc.

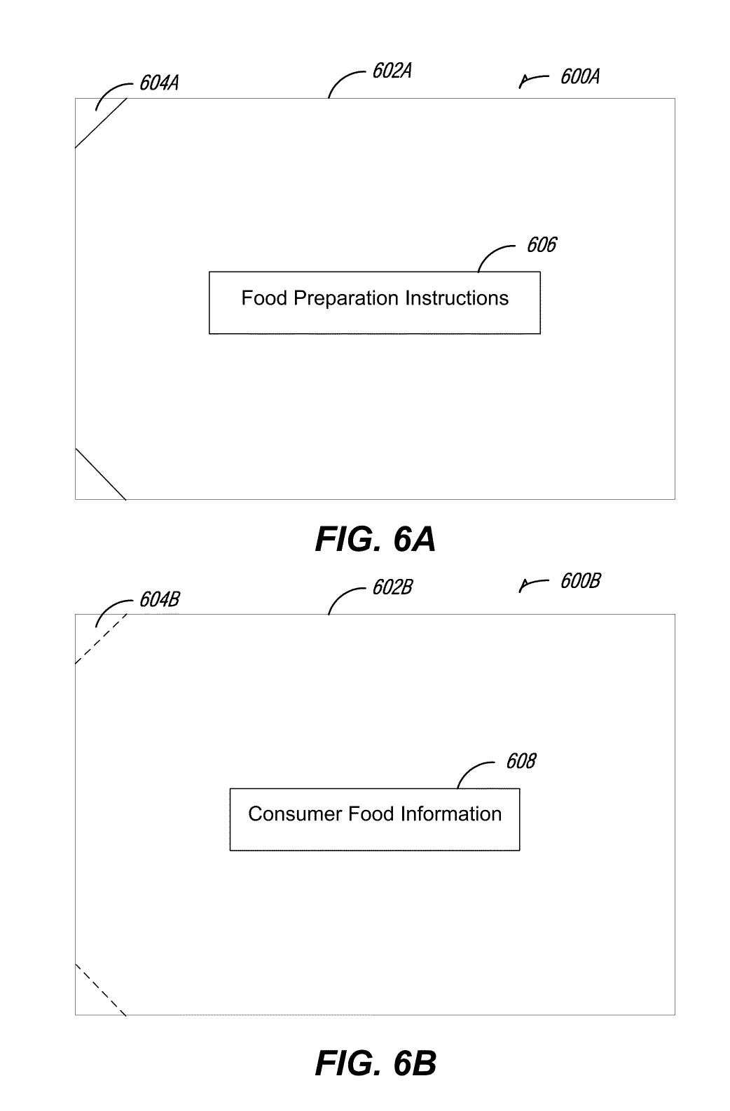

FIG. 6A-6B are diagrams (e.g., 600A and 600B) of a food wrapper label (e.g., 602A and 602B), according to an example embodiment. In FIG. 6A, diagram 600A shows a first view of food wrapper label 602A. The food wrapper label 602A can include an adhesive 604A and a printed information area 606. In an example, the food wrapper label 602A can be used to prepare, wrap, and securely contain or envelope a food order. For example, the printed information area 606 can include food preparation instructions, such as ingredients for a burger or sandwich. After the food is prepared according to the instructions, the food can be placed on the food wrapper label 602A and the food wrapper label 602A can be folded over the food. The adhesive 604A can be used to secure the food in the food wrapper label 602A. The adhesive 604A can be in a corner, a plurality of corners, or placed in another area of the food wrapper label 602A to facilitate securing food in the food wrapper label 602A by affixing the food wrapper label 602A to itself.

Diagram 600B in FIG. 6B shows food wrapper label 602B in an opposite view to food wrapper label 602A of diagram 600A. Adhesive 604B is shown on food wrapper label 602B as being on the opposite side of the view shown in diagram 600B. In another example, adhesive 604B can be on the view shown in diagram 600B on the food wrapper label 602B. In yet another example, an adhesive can be on both sides of the food wrapper label 602A and 602B.

Food wrapper label 602B can include a second printed area 608. In the example shown in diagram 600B, the second printed area 608 includes consumer food information. Consumer food information can include ingredients, order information, nutrition information, a calorie count, unwrapping instructions, caution information (e.g., careful, contents hot, watch for hot cheese, etc.), marketing information, contest details or game pieces, etc. The second printed area 608 can include combinations of information described above. In another example, the second printed area 608 can include a removable label.

In an example, the printed information area 606 or the second printed area 608 can include preprinted information, printed information, or a combination thereof. For example, the printed information area 606 or the second printed area 608 can include color preprinted information, such as a logo, printed information as described above, or a combination. The food wrapper label 602A and 602B can be printed using a printer, such as the printers 202 or 302 described above in FIGS. 2 and 3.

In another example, the food wrapper label 602A and 602B can include a wrapper and a label as separate components. The label can be printed on both sides or can include preprinted information. The label can include adhesive on one or both sides. In an example, the label can be attached to the wrapper using a first portion of adhesive on a first side. The first side of the label can include preparation instructions. The label can include a second portion of adhesive to securely affix the wrapper to itself after food is prepared according to the preparation instructions and the food is placed in the wrapper. The label can include an opposite side of the first side, wherein the opposite side includes consumer information, such as the information described above (e.g., nutrition information, game piece, ingredients, etc.). In this example, the information on the first side of the label is used to prepare the product (e.g., food and wrapper) coupled to the label or enclosed in or by the label.

Preparation instructions on the labels described above can be essential to the end product presented to a consumer. For example, the label can include food preparation instructions, without which the food could not be prepared accurately. The label can be incorporated in the wrapper or attached to the wrapper.

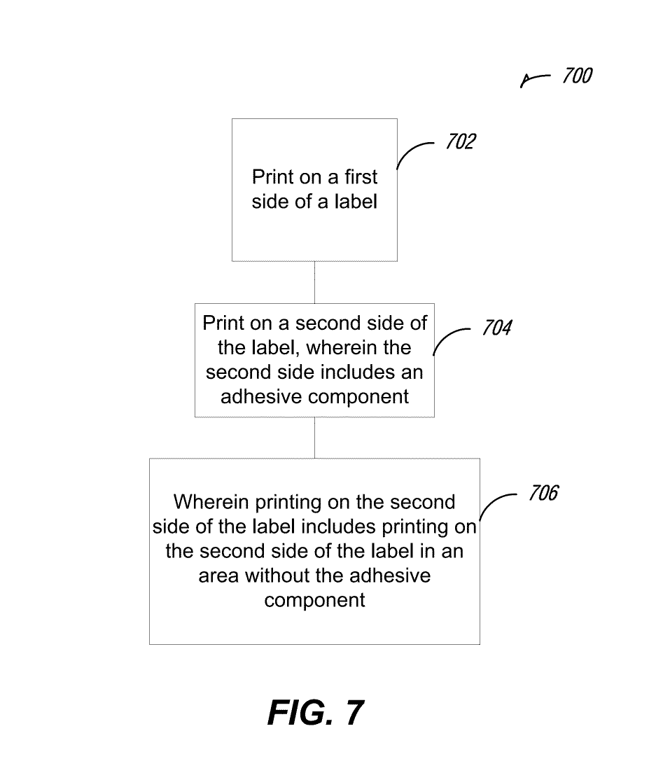

FIG. 7 is a flowchart showing a method 700 for printing on two sides of a label, according to an example embodiment. The method 700 can include an operation 702 to print on a first side of the label. In an example, operation 702 includes printing on the first side of the label using a Self-Service Terminal (SST). The method 700 can include an operation 704 to print on a second side of the label, wherein the second side includes an adhesive component. In another example, the label can include a preprinted area. The preprinted area can be on the first side of the label, the second side of the label, or both. The preprinted area can include information printed in color. Printing on the first side or the second side can include printing in black. The method 700 can include an operation 706 wherein printing on the second side of the label includes printing on the second side of the label in an area without the adhesive component. Operation 706 can include printing on the second side of the label in the area without the adhesive component. The method 700 can include securely enveloping food using the label.

In an example, an SST may include a kiosk (e.g., a movie rental machine, a vending machine, etc.).

In an example, an SST may include an automatic teller machine (ATM).

In an example, an SST may include a point of sale (POS).

In an example, an SST may include a card authentication system, such as for a hotel room key. The card authentication system may include a card matching or generation system or a card authenticator of a pre-made card.

In an example, an SST may include a chip and pin reader for a credit card, a debit card, an identification card, an integrated circuit card (chip card), or the like. For example, the chip and pin reader may be used to purchase goods or withdraw money (e.g., using a Europay MasterCard Visa (EMV) system).

In an example, an SST may include a payment facilitating machine (e.g., a tablet with a card reader, etc.).

### VARIOUS NOTES & EXAMPLES

Each of these non-limiting examples can stand on its own, or can be combined in various permutations or combinations with one or more of the other examples.

Example 1 includes the subject matter embodied by a printer for printing on two sides of a label, the printer comprising: a first print head to print on a first side of the label, a second print head to print on a second side of the label, the second side opposite the first side and including an adhesive area and an adhesive-free area, and wherein the second print head is to print on the second side in the adhesive-free area.

In Example 2, the subject matter of Example 1 may optionally include wherein the first print head is longer than the second print head.

In Example 3, the subject matter of one or any combination of Examples 1-2 may optionally include wherein a point of sale (POS) device includes a printer integrated therein.

In Example 4, the subject matter of one or any combination of Examples 1-3 may optionally include wherein the POS includes a Self-Service Terminal (SST).

In Example 5, the subject matter of one or any combination of Examples 1-4 may optionally include wherein the first and second print heads are thermal print heads.

In Example 6, the subject matter of one or any combination of Examples 1-5 may optionally include wherein the printer includes a toggle to activate the second print head, wherein the second print head is to print on the second side only when the second print head is activated.

In Example 7, the subject matter of one or any combination of Examples 1-6 may optionally include wherein the label includes a preprinted area.

In Example 8, the subject matter of one or any combination of Examples 1-7 may optionally include wherein the first print head is to print on the first side of the label in the preprinted area.

In Example 9, the subject matter of one or any combination of Examples 1-8 may optionally include wherein the first print head is to print on the first side of the label in an area other than the preprinted area.

In Example 10, the subject matter of one or any combination of Examples 1-9 may optionally include wherein the preprinted area includes information printed in color and the first and second print head are to print in black.

In Example 11, the subject matter of one or any combination of Examples 1-10 may optionally include wherein the label includes a predetermined length from a linerless label roll.

In Example 12, the subject matter of one or any combination of Examples 1-11 may optionally include wherein the label includes a food wrapper configured to securely contain food.

In Example 13, the subject matter of one or any combination of Examples 1-12 may optionally include wherein the food wrapper includes a preprinted area.

Example 14 includes the subject matter embodied by a method for printing on two sides of a label comprising: printing on a first side of the label, printing on a second side of the label, wherein the second side includes an adhesive component, and wherein printing on the second side of the label includes printing on the second side of the label in an area without the adhesive component.

In Example 15, the subject matter of Example 14 may optionally include wherein printing on the first side of the label includes printing on the first side of the label using a Self-Service Terminal (SST).

In Example 16, the subject matter of one or any combination of Examples 14-15 may optionally include wherein printing on the first side of the label includes printing on the first side of the label using a thermal print head.

In Example 17, the subject matter of one or any combination of Examples 14-16 may optionally include wherein the label includes a preprinted area.

In Example 18, the subject matter of one or any combination of Examples 14-17 may optionally include wherein printing on the second side of the label includes printing on the second side of the label in the area without the adhesive component.

In Example 19, the subject matter of one or any combination of Examples 14-18 may optionally include wherein printing on the first side of the label includes printing on the first side of the label using in an area overlapping the adhesive component.

In Example 20, the subject matter of one or any combination of Examples 14-19 may optionally include wherein the preprinted area includes information printed in color and printing on the first side of the label includes printing in black on the first side of the label.

In Example 21, the subject matter of one or any combination of Examples 14-20 may optionally include wherein the label includes a predetermined length from a linerless label roll.

In Example 22, the subject matter of one or any combination of Examples 14-21 may optionally include further comprising securely enveloping food using the label.

Example 23 includes the subject matter embodied by a label comprising: a first side including first printed information, and a second side opposite the first side, the second side comprising: an adhesive area, and an adhesive-free area, the adhesive-free area including second printed information, wherein the second printed information provides instructions for preparing a product to be coupled to the label.

In Example 24, the subject matter of Example 23 may optionally include wherein the first and second printed information includes thermal printed information.

In Example 25, the subject matter of one or any combination of Examples 23-24 may optionally include wherein the first side includes a preprinted area in color and the printed information includes black printed information.

In Example 26, the subject matter of one or any combination of Examples 23-25 may optionally include wherein the preprinted area and the second printed information at least partially overlap.

In Example 27, the subject matter of one or any combination of Examples 23-26 may optionally include wherein the label further comprises a predetermined length from a linerless label roll.

In Example 28, the subject matter of one or any combination of Examples 23-27 may optionally include wherein the label is configured to securely contain food.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A printer for printing on two sides of a label, the printer comprising:
a first print head to print on a first side of the label;
a second print head to print on a second side of the label, the second side opposite the first side and including an adhesive area and an adhesive-free area; and
wherein the second print head is to print on the second side in the adhesive-free area.

2. The printer of claim 1, wherein the first print head is longer than the second print head.

3. The printer of claim 1, wherein a point of sale (POS) device includes a printer integrated therein.

4. The printer of claim 1, wherein the first and second print heads are thermal print heads.

5. The printer of claim 1, wherein the printer includes a toggle to activate the second print head, wherein the second print head is to print on the second side only when the second print head is activated.

6. The printer of claim 1, wherein the label includes a preprinted area.

7. The printer of claim 6, wherein the first print head is to print on the first side of the label in the preprinted area.

8. The printer of claim 6, wherein the first print head is to print on the first side of the label in an area other than the preprinted area.

9. The printer of claim 6, wherein the preprinted area includes information printed in color and the first and second print head are to print in black.

10. The printer of claim 6, wherein the label includes a predetermined length from a linerless label roll.

11. The printer of claim 1, wherein the label includes a food wrapper configured to securely contain food.

12. A method for printing on two sides of a label comprising:
printing on a first side of the label;
printing on a second side of the label, wherein the second side includes an adhesive component; and
wherein printing on the second side of the label includes printing on the second side of the label in an area without the adhesive component.

13. The method of claim 12, wherein printing on the first side of the label includes printing on the first side of the label using a Self-Service Terminal (SST).

14. The method of claim 12, wherein the label includes a preprinted area.

15. The method of claim 14, wherein the preprinted area includes information printed in color and printing on the first side of the label includes printing in black on the first side of the label.

16. The method of claim 12, wherein printing on the second side of the label includes printing on the second side of the label in the area without the adhesive component.

17. The method of claim 12, further comprising securely enveloping food using the label.

18. A label comprising:
a first side including first printed information; and
a second side opposite the first side, the second side comprising:
an adhesive area; and
an adhesive-free area, the adhesive-free area including second printed information, wherein the second printed information provides instructions for preparing a product to be coupled to the label.

19. The label of claim 18, wherein the label further comprises a predetermined length from a linerless label roll.

20. The label of claim 18, wherein the label is configured to securely contain food.
